(19) United States
(12) Patent Application Publication
(10) Pub. No.: US 2021/0064672 A1
(43) Pub. Date: Mar. 4, 2021

(54) Method and System for Refactoring Document Content and Deriving Relationships Therefrom

(71) Applicants: Sanjay G. Mahadi, Dublin, CA (US); Richard V. Rifredi, Los Gatos, CA (US)

(72) Inventors: Sanjay G. Mahadi, Dublin, CA (US); Richard V. Rifredi, Los Gatos, CA (US)

(21) Appl. No.: 17/011,092

(22) Filed: Sep. 3, 2020

Related U.S. Application Data
(60) Provisional application No. 63/037,139, filed on Jun. 10, 2020.
(60) Provisional application No. 62/895,636, filed on Sep. 4, 2019.

(51) Int. Cl. G06F 16/903; G06N 20/00; G06F 16/16; G06F 40/58

(52) U.S. Cl. CPC G06F 16/90344; G06F 40/58; G06F 16/164; G06N 20/00

(57) ABSTRACT

A method and system for refactoring document content and deriving relationships therefrom are described. For each page of a document to be processed, a processing engine processes a page of the document to create a summary and metadata relating to the page, determines a keyphrase relating to the summary, generates links to other content based on the keyphrase, and stores the summary, the keyphrase, the links, and the metadata. A search engine processes a search term, retrieves a page of a document containing the search term, and returns only the page that contains the search term and not the entire document that contains the search term.

### CROSS-REFERENCE TO RELATED APPLICATIONS

This application claims priority to and the benefit of U.S. Provisional Application No. 62/895,636 filed Sep. 4, 2019, and U.S. Provisional Application No. 63/037,139 filed Jun. 10, 2020, the entire disclosures of which are hereby incorporated by reference.

### TECHNICAL FIELD

The present disclosure relates to a system and method to provide access to information contained in electronic content including, but not limited to, electronic documents, multimedia files, images, and textual data from repositories and Web sites, without having to read through the content in a predetermined order. More specifically, the present disclosure relates to a system and method to provide a multi-dimensional view of content, aiding quick visual navigation of the content based on augmented extracted summaries and keywords using semantic and linguistic relationships of words and phrases in the original content.

### BACKGROUND

Electronic content in various forms of text, audio, video, images, emails, instant messages (IMs) etc. has proved to be a good tool for knowledge capture and distribution. Electronic content repositories in private and public networks continue to grow exponentially due to various factors of speed, cost, and convenience added by adoption of paperless initiatives, regulatory mandates, and business process maturity improvements.

A component of a content repository of a company is the knowledge (in documents of various content types) that is developed and maintained to provide useful information to individuals and employees to perform their duties effectively. This knowledge is constantly generated and cross-referenced to propagate valuable information, but due to an emerging trend of reduced attention spans combined with ever-increasing busy lifestyles of people, the content, especially content in long-form documents, frequently goes unread. The gap or loss of using the valuable information contained in the documents may detrimentally impact the growth of individual or company's intellectual capital.

This problem cannot be solved by old solutions of training, behavior modifications, or improved corporate culture, and requires a different approach, adopting current trends, technological advancements, and addressing the needs of fast direct access to specific information. The approach needs to eliminate indirection of finding the document and then finding the information somewhere inside the document. Further, there is a need to find information within a designated corpus of information that eliminates erroneous information from generalized Internet searches. Many current search systems are keyword-based and it is up to the user to determine the correct keyword to search. In some instances, the content that is most relevant to the user may be found with a keyword that is related to, but different from, the keyword that the user entered for the search topic. In current search systems, the most relevant content might be missed by the user because the entered keyword was not an exact match.

Therefore, there is a need for a system and method to provide an easy approach to search, navigate, consume, read, and share information from document contents (including text, images, and multimedia) that is processed to summarize, label, tag/index, and relate to topics using semantic and linguistic relationships of words and phrases contained in the document. Further, there is need for a system and method to transform electronic content into multidimensional flash cards of information that are labeled with tagged keywords, cross-linked with information from other content sources, and grouped under a particular topic/domain with added enrichment from external sources. These cards may then be shared with other users of the system.

### SUMMARY

Disclosed herein are implementations of a method and a system for refactoring document content and deriving relationships therefrom.

One aspect of this disclosure describes a method for refactoring document content and deriving relationships therefrom. For each page of a document to be processed, the method includes processing a page of the document by a processing engine to create a summary and metadata relating to the page; determining a keyphrase relating to the summary, the determining performed by the processing engine; generating links to other content based on the keyphrase, the generating performed by the processing engine; and storing the summary, the keyphrase, the links, and the metadata.

Another aspect of this disclosure describes a system for refactoring document content and deriving relationships therefrom. A processing engine processes a document using a machine learning algorithm, including for each page of the document: creating a summary and metadata relating to a page; determining a keyphrase relating to the summary; generating links to other content based on the keyphrase; and storing the summary, the keyphrase, the links, and the metadata.

Another aspect of this disclosure describes a non-transitory computer readable medium containing instructions thereon for execution by a processor. For each page of a document to be processed, the instructions include a processing code segment for processing a page of the document to create a summary and metadata relating to the page; a determining code segment for determining a keyphrase relating to the summary; a generating code segment for generating links to other content based on the keyphrase; and a storing code segment for storing the summary, the keyphrase, the links, and the metadata.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a diagram of a knowledge model.

FIG. 2 is a diagram showing an example of a topic and documents arranged according to the knowledge model.

FIG. 3 is a block diagram of an overview of a system to implement the knowledge model.

FIG. 4 is a flowchart of a method for processing a document to create the components of the knowledge model.

FIG. 5 is a flowchart of a method for searching within the knowledge model.

FIG. 6 is an example screen display showing the results of a query.

FIG. 7 is an example of an original content page of a single card retrieved from a query.

### DETAILED DESCRIPTION

The method and system described herein process a source document to extract information from the document; label, tag with keywords or keyphrases, and index the extracted information; and connect the extracted information to other topically-related content across multiple documents. This processing effectively creates multidimensional microcontent, which summarizes the content from pages in each source document. Presented in this manner, a user may read the topic-relevant content from a source document without having to read the entire source document. For example, if a search result identifies a fifty page document as containing the most relevant information to the user's search, but the most relevant information is only contained on a single page of the document, the method and system described herein present a summary of that single page to the user without the user having to open the document and read the entire fifty page document.

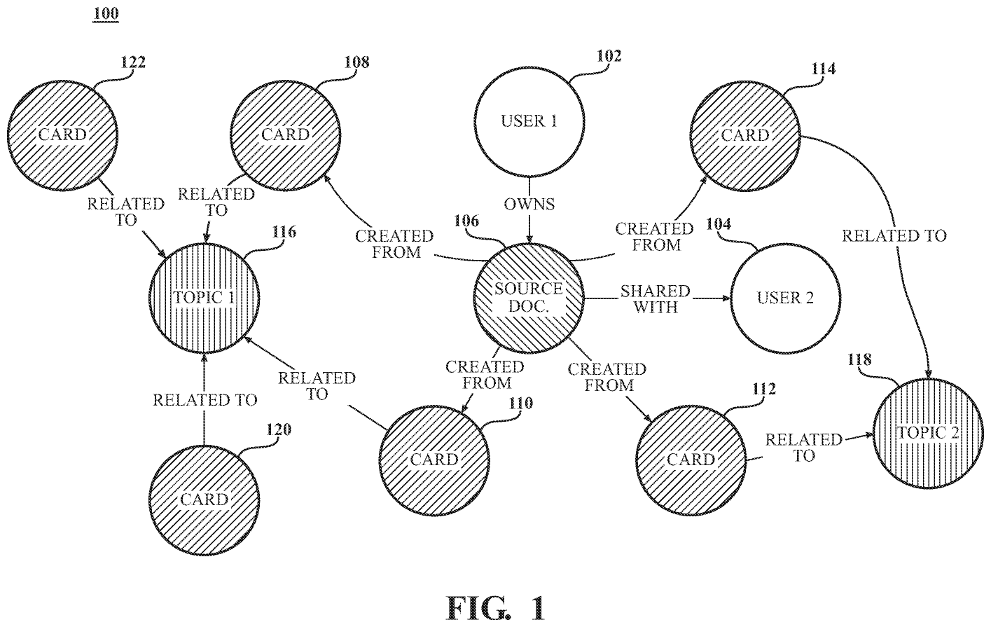

FIG. 1 is a diagram of a knowledge model 100. A first user 102 and a second user 104 are shown using the model 100. It is noted that any number of users may use the model 100; two users are shown herein to simplify the explanation. The first user 102 is considered an owner of a source document 106 if the first user 102 uploads or otherwise identifies the source document 106 to the model 100. The first user 102 may designate that the source document 106 can be shared with the second user 104. In some embodiments, system preferences (and not the first user 102) may control whether the second user 104 can access the cards created from the source document 106. The source document 106 is processed by the model 100, as will be explained in further detail below. The processing of the source document 106 creates one or more “cards,” shown in FIG. 1 as cards 108, 110, 112, and 114. It is noted that any number of cards may be created from the source document 106.

Taking card 108 as an example, the card 108 relates to a single topic contained in the source document 106. The information contained in the card 108 can be text, an image, a video, a spreadsheet, or any other content that can be extracted from the source document 106. In some implementations, the content of the card 108 relates to the content of a single page of the source document 106. It is noted that while cards 110, 112, and 114 are all extracted from the same source document 106 as the card 108, the content of the cards 108, 110, 112, and 114 will be different. All of the cards created from a single source document 106 (e.g., cards 108, 110, 112, and 114) may also be referred to herein as a “card cloud.”

In the model 100, a “topic,” such as a first topic 116, connects various cards together that relate to the same topic. For example as shown in FIG. 1, the first topic 116 is related to cards 108 and 110 from source document 106 and cards 120 and 122 from one or more other source documents (not shown in FIG. 1). When a user searches for the first topic 116 (as will be explained in further detail below), the user retrieves cards 108, 110, 120, and 122 (as described below, the cards displayed to the user may vary depending on a context of the user and/or access permissions of the user).

A second topic 118 is related to cards 112 and 114, created from the source document 106. Because any source document 106 may contain multiple topics, the first topic 116 and the second topic 118 may relate to cards created from the same source document 106.

The model 100 is based on topic-oriented information seeking, instead of document-oriented information seeking, so that when a user performs a search, the user retrieves all information relevant to the topic, regardless of the source document. A topic (e.g., first topic 116 and second topic 118) includes the name of the topic along with keyphrases (which may include one or more words), and does not include the actual content; the actual content is stored in the individual cards. In this respect, a topic acts like a hub that connects similar content referring to the same topic. As used herein, a topic may be referred to as “connector,” and all of the cards associated with a given topic (regardless of the source document) may be referred to as a “connector cloud.” A “library” (not shown in FIG. 1) is a collection of card clouds and connectors, and there are different levels of libraries. For example, a personal library includes all documents added by a user, all cards created from those documents, and all topics relating to those cards. A team library includes all documents, cards, and topics accessible to a predefined team or group of users. A company library includes all documents, cards, and topics accessible to any user in the company.

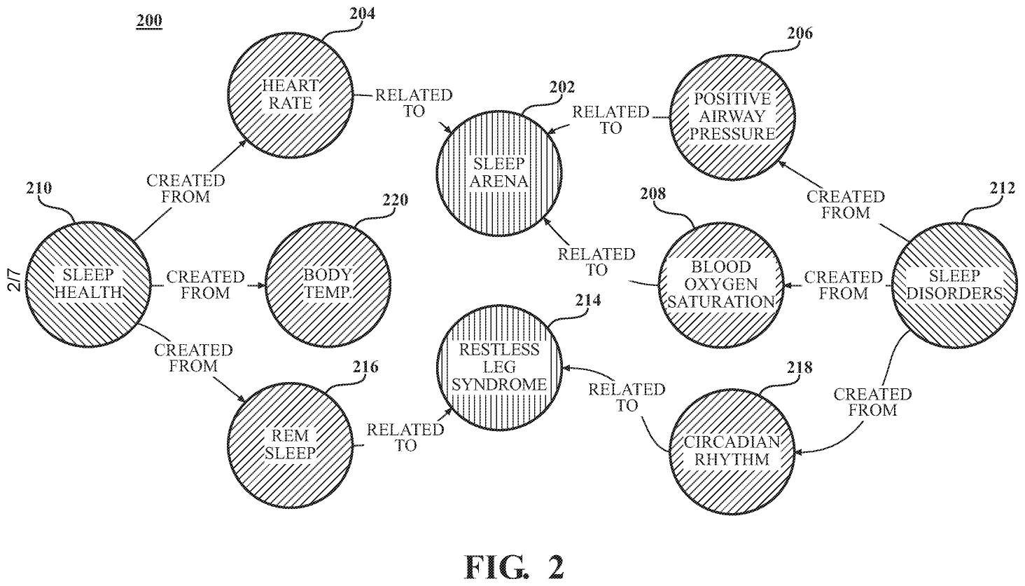

FIG. 2 is a diagram showing an example 200 of two topics, six cards, and two source documents arranged according to the knowledge model 100. In the example 200, a first topic 202 (labeled “sleep apnea”) has three cards related to it: a first card 204 (labeled “heart rate”), a second card 206 (labeled “positive airway pressure”), and a third card 208 (labeled “blood oxygen saturation”). The first card 204 was created from a first source document 210 (labeled “sleep health”). The second card 206 and the third card 208 were created from a second source document 212 (labeled “sleep disorders”).

A second topic 214 (labeled “restless leg syndrome”) has two cards related to it: a fourth card 216 (labeled “REM sleep”) and a fifth card 218 (labeled “circadian rhythm”). The fourth card 216 was created from the first source document 210, and the fifth card 218 was created from the second source document 212. A sixth card 220 (labeled “body temp.”) was created from the first source document 210 and is related to a third topic (not shown in FIG. 2).

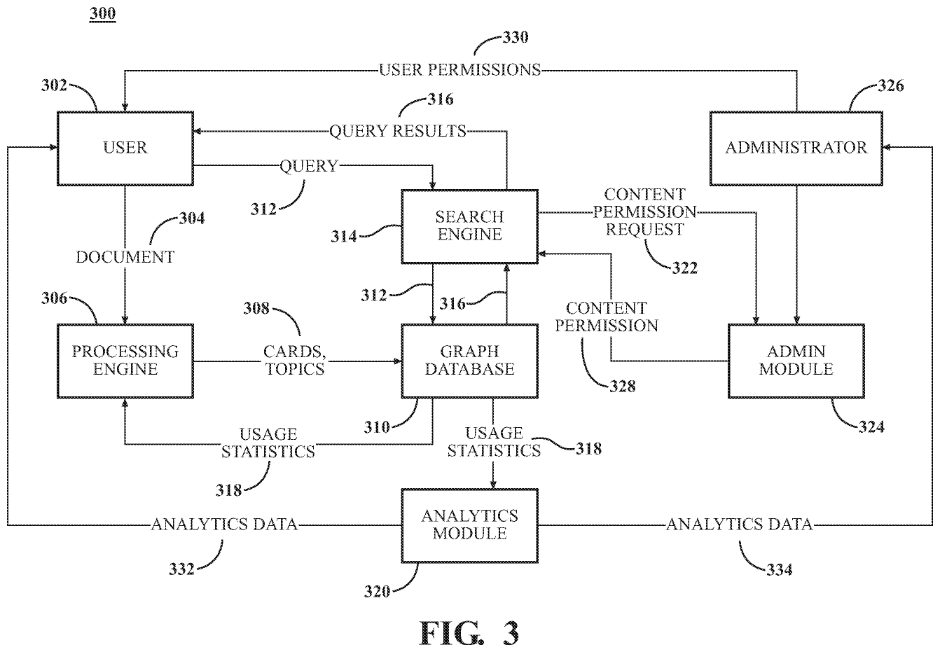

FIG. 3 is a block diagram of an overview of a system 300 to implement the knowledge model 100. A user 302 uploads or otherwise identifies a document 304 to be processed by a processing engine 306. The processing engine 306 processes the document 304 to create cards, topics, and connections 308 between the cards and the topics and stores the cards, topics, and connections 308 in a graph database 310. In some implementations, the document 304 and the cards created from the document 304 may not be stored in the graph database 310; only the topics and connections may be stored in the graph database 310. In some implementations, a database structure other than a graph database may be used without adversely affecting the operation of the system 300. Additional details of how the processing engine 306 processes the document 304 to create the cards, topics, and connections 308 will be explained in further detail below.

When a user 302 searches for a topic, the user 302 enters a query 312, which is sent to a search engine 314 for processing. The search engine 314 forwards the query 312 to the graph database 310 which returns query results 316 to the search engine 314. The search engine 314 returns the query results 316 to the user 302 in a manner that will be explained in further detail below. Statistics relating to how the user 302 interacts with the query results 316 are provided as usage statistics 318 to an analytics module 320. The usage statistics 318 are also provided to the processing engine 306 to assist the processing engine 306 in processing later documents 304 submitted by the user 302, as will be explained in further detail below.

In some instances, when the user 302 submits the query 312, the user 302 may need permission to access the content relating to the query 312. In these instances, the search engine 314 sends a content permission request 322 to an administration module 324 which is controlled by an administrator 326. If the user 302 has permission to access the content relating to the query 312, the content permission 328 is sent from the administration module 324 to the search engine 314 to permit the user 302 to access the query results 316. In some implementations, the content permission 328 may instruct the search engine 314 to filter out certain query results 316 that the user 302 does not have access to, yet still permit the search engine 314 to display some query results 316 to the user 302. The administrator 326 may establish the content permission 328 and other user permissions 330 in a role-based manner, for example, such that any user 302 with a similar role (e.g., all users in a predetermined group of users) has similar content permissions 328 and user permissions 330. When a user 302 registers with the system 300, a context for the user 302 is established. This context may include setting access permission levels for the user 302, for example, what cards or topics the user 302 may access. The context of a user 302 may also determine how documents 304 provided by the user 302 are shared within the system 300.

The analytics module 320 processes the usage statistics 318 to generate analytics data 332 sent to the user 302 and analytics data 334 sent to the administrator 326. In some implementations, the analytics data 332 and the analytics data 334 may be the same data, may be partially different data, or may be completely different data. The analytics data 332, 334 may include cognitive scores (representing a depth of knowledge seeking on a particular topic), intellectual scores (representing a breadth of knowledge across all topics), and other internal metrics to generate quantitative measures of how users are using the system 300.

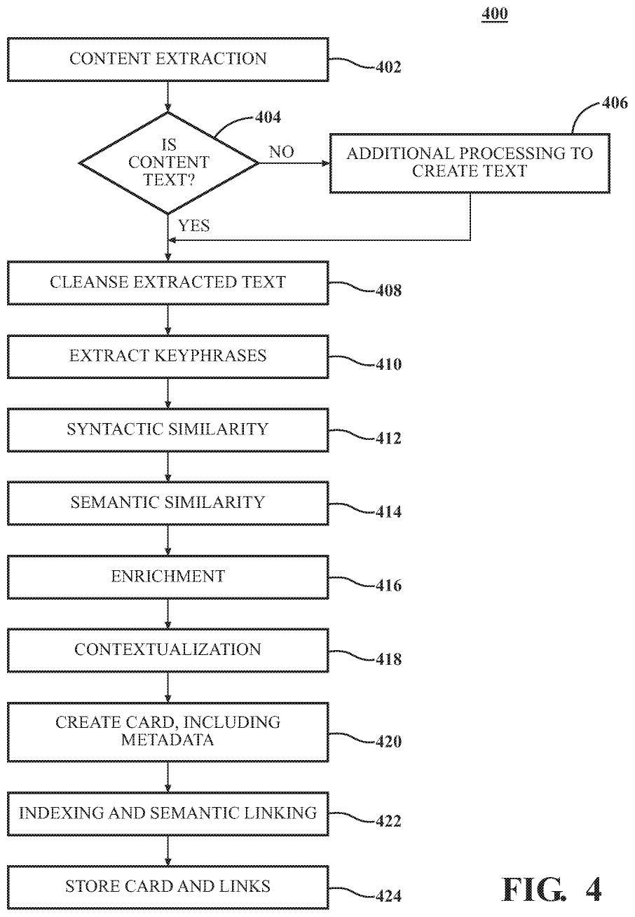

FIG. 4 is a flowchart of a method 400 for processing a document to create the components of the knowledge model 100. After a user 302 uploads or otherwise identifies a document 304 to be processed by the processing engine 306, content is extracted from the document 304 (step 402). The content extraction parses out the content from the document 304, and in step 402 does not attempt to associate any meaning or syntax to the content. If the extracted content is not text (step 404), additional processing is performed on the document 304 to create text from the document (step 406). For example, if the document 304 is a video, then the additional processing includes transcribing audio from the video (e.g., by using a speech to text algorithm) to create text. As another example, if the document 304 includes an image, then the additional processing includes using a computer vision or image recognition algorithm (for example, optical character recognition) to create text. It is noted that any type of document 304 may be processed by the processing engine 306 in a similar manner, including, but not limited to, Portable Document Format (PDF) documents, hypertext markup language (HTML) documents, word processing documents, spreadsheets, forms, slide decks, and plain text.

If the extracted content is text (step 404) or has been converted into text (step 406), the extracted text is cleansed (step 408). The cleansing includes correcting spelling and/or grammar, and removes “gibberish” from the text (e.g., if there are any formatting issues or formatting problems in the document 304, the conversion into text may create unintelligible sequences of characters, and these sequences would be removed). At this point, one or more summaries of the page have been created.

In some implementations, if the document 304 is in a non-English language (determined after the extracted text is cleansed in step 408), the text of the document is translated into English for subsequent processing (this step is not shown in FIG. 4).

Keyphrases are extracted from the cleansed text (step 410). In extracting keyphrases from the cleansed text, a word count process may be performed, counting the frequency of a given word on a page of the document 304 and/or throughout the entire document 304. The extracted keyphrases are then associated with the page and document.

Syntactic similarity is performed by looking for syntactic similarity with other content by, for example, matching keyphrases with other content from a different card or a different topic (step 412). This step may also include determining how much other already processed content exists in the graph database 310 that is similar to the document 304 being processed.

Semantic similarity is performed by the processing engine 306 attempting to determine the meaning of each extracted word and to determine if there is other content that matches or is similar in meaning to the extracted word (step 414).

Enrichment is performed (step 416), which adds content relevant to the content of the document being processed. In some implementations, enrichment adds information from other sources to a card or to a card cloud. For example, this information may include additional text, images, audio, video, or other media.

Contextualization is performed (step 418), and may include categorizing the content with a natural language processing (NLP) algorithm, categorizing the content based on company-wide preferences, and/or be determined by a context of the user 302 that identified the document 304. The context of the user 302 may include metadata such as the department that the user belongs to (e.g., marketing or engineering), the user's preferences, or the user's prior usage statistics 318 and/or analytics data 332. In some implementations, contextualization is also performed at multiple levels of a hierarchy, for example, at a user level, at a team level, and at a company level.

A card is created, including the extracted keyphrases, the summary, and metadata extracted from the original document 304 (step 420). The processing engine 306 creates concise text from the preceding steps, including forming concise sentences summarizing the processed text. Any images or videos that are associated with the text may be added to the card. In some implementations, the metadata extracted from a given document 304 is also separately stored in a repository of metadata for all documents. Separately storing the metadata may permit metadata-driven searches for content or be used to relate the metadata to other content.

Indexing and semantic linking are performed (step 422), to relate the created card to a topic. In some implementations, the processing engine 306 determines the topic that best relates to the content of the card and searches the graph database 310 for additional information relating to the topic, to better fit the card into the index and existing topics. If the topic the best relates to the card does not currently exist in the graph database 310, then a new topic is created and the card is related to the newly created topic.

The created card and associated links are stored in the graph database 310 (step 424). As noted above, in some implementations, the created card may be stored in a database other than the graph database 310 and the links may be stored in the graph database 310. Based on the method 400, the source document has been refactored (i.e., restructured) into the multiple cards without altering the content of the source document. In some implementations, each document is converted by the method 400 into a separate graph of cards and links, and all of the separate graphs are stored together in the graph database 310.

The steps of the method 400 may be performed by different natural language processing (NLP) algorithms, computational linguistics algorithms, and machine learning algorithms. While particular NLP algorithms perform particular functions, the choice of a specific NLP algorithm for performing a specific step of the method 400 does not affect the overall operation of the method 400. In some implementations, the machine learning algorithms used in the method 400 provide feedback to improve processing for subsequent documents. For example, the feedback may include, but is not limited to, word frequency counts (e.g., at a paragraph, page, or document level), various scores (e.g., to understand the proximity of words in a page or a document), a syntax score, a semantic score, or a lexical score. In some implementations, the feedback is particular to a user and the user's settings, and the feedback is applied to processing subsequent documents identified by the user. In some implementations, the processing engine 306 adjusts its processing parameters based on the feedback. In some implementations, if the user is new to the system and/or there are no associated settings, then baseline settings may be applied as document processing parameters.

In some implementations, the method 400 is performed for each page of a document 304, creating a separate card and links for each page. In some implementations, there may be multiple cards created from a single page of the source document. For example, processing a twenty page document may create thirty separate cards and any number of links to different topics and between the cards. The method 400 achieves two goals when processing a document: first, the method 400 collects all of the information from a single source document in a multidimensional manner, and second (and in parallel), the method 400 establishes connections to other source documents and other content relating to the same topic.

In some implementations, a card may be manually created by a user. In these implementations, after manual card creation, the method 400 begins with step 410.

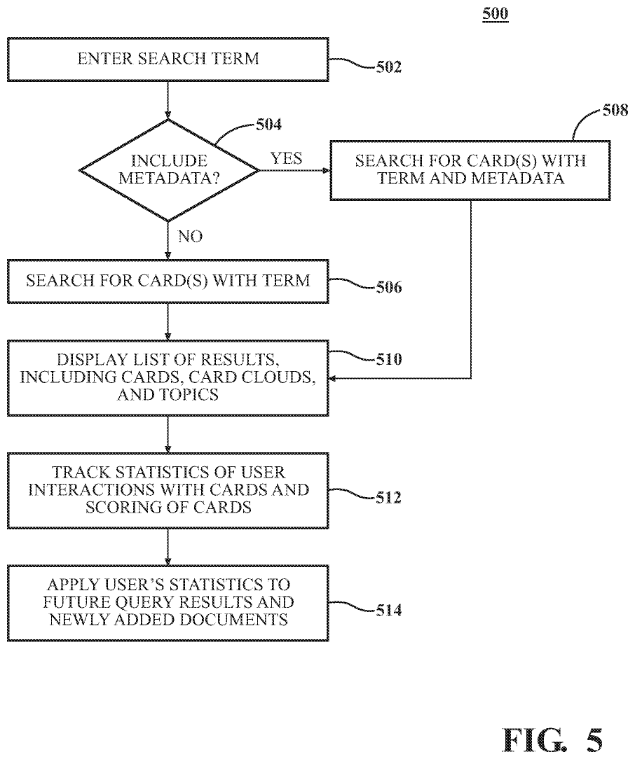

FIG. 5 is a flowchart of a method 500 for searching within the knowledge model 100. A user 302 enters a search term, which may also include metadata (step 502). If the search term does not include metadata (step 504), then a search is performed to look for cards containing the search term (step 506). If the search term includes metadata (step 504), then a search is performed to look for cards containing the search term and the metadata (step 508). In either step 506 or step 508, the search is presented as a query 312 to the search engine 314. The search algorithm in the search engine 314 automatically determines if the search term contains metadata. In some implementations, the search algorithm uses a combination of semantic and syntactic matching with information from the contents, content metadata, and the knowledge model to find matching results. The search engine 314 sends the query 312 to the graph database 310 for execution. The graph database 310 returns the query results 316 to the search engine 314, which displays the query results 316 to the user 302 as a list including cards, card clouds, and topics (step 510).

Based on the knowledge model 100, when a user 302 searches for a topic, the list of cards displayed to the user may come from multiple different source documents and may include all cards connected to the search topic. In some implementations, the list of cards may be filtered based on a context of the user 302. For example, a user in the marketing department may receive a different list of cards than a user in the engineering department for the same search topic. This context-based filtering provides a user 302 with search results that are most relevant to the user's context.

In some implementations, the query results are ordered based on search keyphrase relevancy. In some implementations, the query results are ordered by recency (e.g., the most recently created cards are listed first) and/or by user ratings. In some implementations, the user may include metadata in the search term to retrieve a particular page from a specified document. For example, if the user entered “show page 12 from 2019 Sales spreadsheet” as the query 312, the query results 316 would only include page 12 from the 2019 Sales spreadsheet. The query results 316 would not include the entire 2019 Sales spreadsheet and then leave it to the user to navigate to page 12. An example query result is explained in further detail below.

As the user 302 interacts with the displayed cards, the system 300 tracks statistics of the user's interactions and a scoring of the cards provided by the user 302 (step 512). These tracked statistics are provided as the usage statistics 318 to the analytics module 320 for additional processing, as described above. The usage statistics 318 are also provided to the processing engine 306 to apply the statistics to new documents 304 that are identified by the user 302 to the system 300, to assist the processing engine 306 in processing the new documents 304. The usage statistics 318 are also used by the graph database 310 and the search engine 314 to provide better query results to the user 302 (step 514). For example, if the user 302 prefers cards that are created from a particular source document or by a particular author, then for future searches performed by the user 302, the query results 316 will include cards from the particular source document, all documents from the same source, or by the particular author at a higher ranking within the query results.

In some implementations, the connections between a topic and the cards that are related to that topic may evolve during use of the system 300. For example, the number of cards displayed as the query results 316 may be limited and the cards may be ranked based on the user's preferences, prior query results, and/or prior user interactions with the query results. It is noted that the cards connected to a topic do not change, and that the displayed query results may evolve.

In some implementations, the cards displayed in the query results may be automatically translated into the user's native language. The translations may be triggered by the user's context and other metadata relating to the retrieved cards.

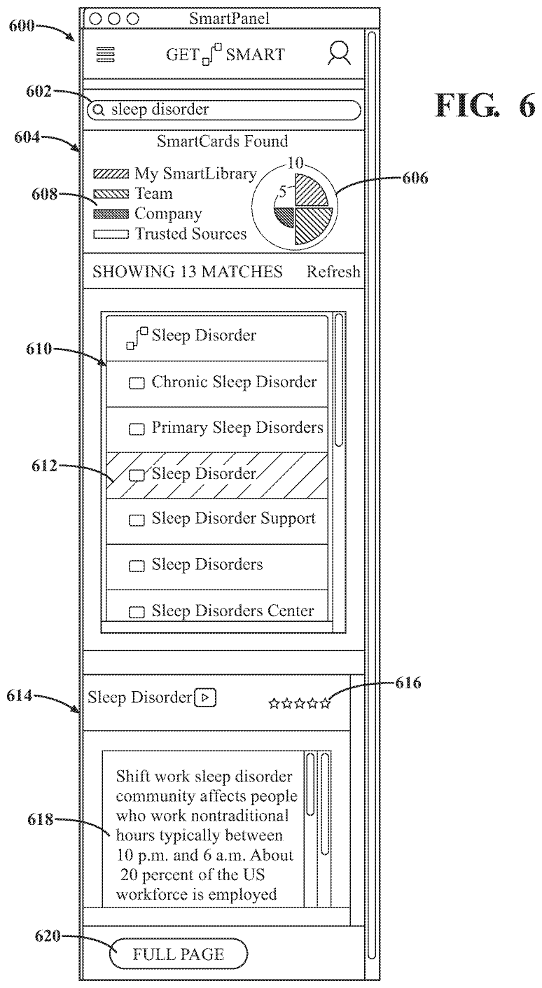

FIG. 6 is an example screen display showing the results of a query. A search panel 600 may be a portion of a screen of a Web browser or may be an entire screen by itself. The search panel 600 includes a search term field 602. A results summary 604 (based on the results of the search) includes a graphical indicator 606 showing the sources of the query results and identified by a key 608. In some embodiments, the graphical indicator 606 and the key 608 may take different forms, including different layouts or arrangements of the summary information.

A results list 610 includes all of the results retrieved from the query. As noted above, the results list 610 may display cards, card clouds, and/or topics. In some implementations, the results list 610 may be filtered based on a user's context and/or settings. A user may select an individual result 612, which is displayed below the results list 610 as a selected result display 614. The selected result display 614 includes a rating 616 that is completable by the user and a search result content 618 that displays at least a portion of the content from the selected result 612. A control button 620 may be used to display the entirety of the selected result 612.

In some implementations, the search panel 600 is an extension to a Web browser and is integrated into the Web browser to display the search panel 600 alongside typically retrieved Internet search results.

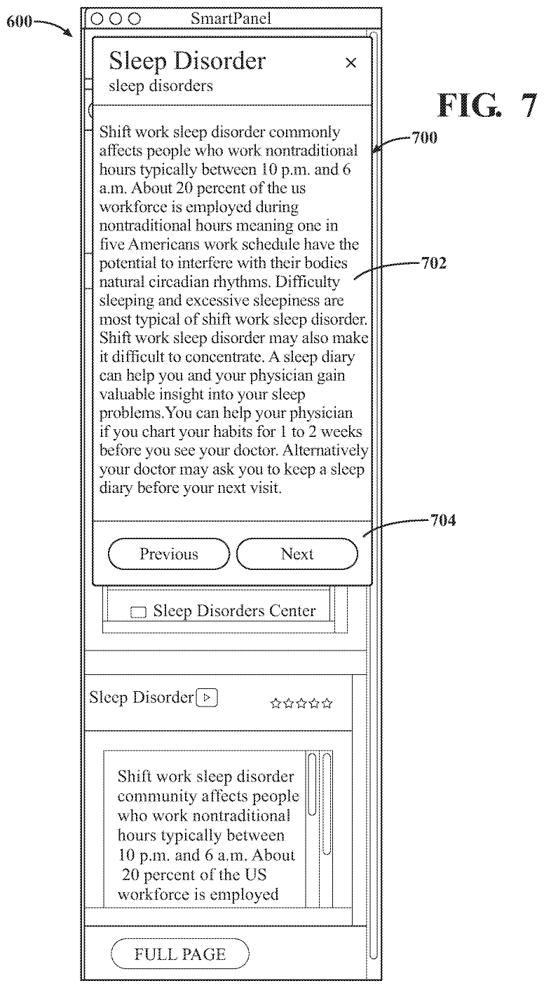

FIG. 7 is an example of an original content page of single card retrieved from a query. If the user activates the control button 620 (as shown in FIG. 6), the selected result 612 is displayed as a selected result card 700. In some implementations, the selected result card 700 is overlaid on the search panel 600. In some implementations, the selected result card 700 is displayed elsewhere on the user's display and may not overlay or may only partially overlay the search panel 600. The selected result card 700 shows the card contents 702. It is noted that the card contents 702 may be sized to be fully displayed within the selected card result 700 or may be sized to be partially displayed within the selected card result 700 and include appropriate navigation controls so the user may view the entire card contents 702. Card navigation controls 704 allow the user to change the selected result card 700, to display other items from the results list 610 without having to return to the search panel 600 to select a different selected result 612.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for refactoring document content and deriving relationships therefrom, comprising:
for each page of a document to be processed:
processing a page of the document by a processing engine to create a summary and metadata relating to the page;
determining a keyphrase relating to the summary, the determining performed by the processing engine;
generating links to other content based on the keyphrase, the generating performed by the processing engine; and
storing the summary, the keyphrase, the links, and the metadata.

2. The method of claim 1, wherein the processing the page is automatically performed by a machine learning algorithm.

3. The method of claim 2, wherein the machine learning algorithm provides feedback to the processing engine for processing subsequent documents.

4. The method of claim 3, wherein the feedback includes any one or more of: settings of a user, usage statistics of the user, a word frequency count, a syntax score, a semantic score, or a lexical score.

5. The method of claim 1, further comprising:
processing a search term by a search engine, including:
retrieving a page of a document that contains the search term; and
returning only the page that contains the search term and not the entire document that contains the search term.

6. The method of claim 5, wherein the search term includes the keyphrase.

7. The method of claim 5, wherein:
the search term includes the keyphrase and metadata; and
the search engine is configured to automatically extract the metadata from the search term.

8. The method of claim 5, wherein the processing the search term further includes performing a semantic search on the search term to retrieve pages that contain terms similar to the search term.

9. The method of claim 5, wherein the processing the search term further includes automatically translating the retrieved page into a user's preferred language.

10. A system for refactoring document content and deriving relationships therefrom, comprising:
a processing engine configured to process a document using a machine learning algorithm, including for each page of the document:
creating a summary and metadata relating to a page;
determining a keyphrase relating to the summary;
generating links to other content based on the keyphrase; and
storing the summary, the keyphrase, the links, and the metadata.

11. The system of claim 10, wherein the processing engine is further configured to adjust processing parameters based on feedback received from the machine learning algorithm.

12. The system of claim 11, wherein the feedback includes any one or more of: settings of a user, usage statistics of the user, a word frequency count, a syntax score, a semantic score, or a lexical score.

13. The system of claim 10, further comprising:
a search engine configured to process a search term, including:
retrieving a page of a document that contains the search term; and
returning only the page that contains the search term and not the entire document that contains the search term.

14. The system of claim 13, wherein the search term includes the keyphrase.

15. The system of claim 13, wherein:
the search term includes the keyphrase and metadata; and
the search engine is further configured to automatically extract the metadata from the search term.

16. The system of claim 13, wherein the search engine is further configured to perform a semantic search on the search term to retrieve pages that contain terms similar to the search term.

17. The system of claim 13, wherein the search engine is further configured to automatically translate the retrieved page into a user's preferred language.

18. A non-transitory computer readable medium containing instructions thereon for execution by a processor, the instructions comprising:
for each page of a document to be processed:
a processing code segment for processing a page of the document to create a summary and metadata relating to the page;
a determining code segment for determining a keyphrase relating to the summary;
a generating code segment for generating links to other content based on the keyphrase; and
a storing code segment for storing the summary, the keyphrase, the links, and the metadata.

19. The non-transitory computer readable medium of claim 18, wherein:
the processing code segment includes a machine learning algorithm that provides feedback to the processing code segment for processing subsequent documents.

20. The non-transitory computer readable medium of claim 18, further comprising:
a second processing code segment for processing a search term, including:
a retrieving code segment for retrieving a page of a document that contains the search term; and
a returning code segment for returning only the page that contains the search term and not the entire document that contains the search term.

21. The non-transitory computer readable medium of claim 20, wherein:
the search term includes the keyphrase and metadata; and
the second processing code segment automatically extracts the metadata from the search term.

22. The non-transitory computer readable medium of claim 20, wherein the second processing code segment performs a semantic search on the search term to retrieve pages that contain terms similar to the search term.

23. The non-transitory computer readable medium of claim 20, wherein the second processing code segment automatically translates the retrieved page into a user's preferred language.
